(19) United States
(12) Patent Application Publication
(10) Pub. No.: US 2004/0034580 A1
(43) Pub. Date: Feb. 19, 2004

(54) Merchandise control system

(75) Inventor: Eiji Okamura, Tokyo (JP)

Correspondence Address: FULBRIGHT AND JAWORSKI L L P, PATENT DOCKETING 29TH FLOOR, 865 SOUTH FIGUEROA STREET, LOS ANGELES, CA, 900172576

(73) Assignee: Leading Information Technology Institute, Inc.

(21) Appl. No.: 10/223,804

(22) Filed: Aug. 19, 2002

(51) Int. Cl. G06F 17/60

(52) U.S. Cl. 705/28

(57) ABSTRACT

A merchandise control system accurately keeps track of merchandise volume, thereby solving the problem of ambiguity that existed in the actual sales volume and the required replenishment quantity because of the inability to differentiate between disbursements of articles from warehouse adjacent to a store and actual sales. The merchandise control system preferably includes a merchandise quantity information store 1, a merchandise quantity information updater 2, a merchandise quantity information history store 3, and a merchandise quantity information and merchandise quantity information history provider 4.

### TECHNICAL FIELD

The present invention relates to a merchandise control system that manages the sales volume of articles with a short sales season, for example by auctioning high volume products in a virtual store established in a computer.

### BACKGROUND

When selling apparel, shoes, handbags, wallets, and other merchandise, having various types of articles available and displaying them in an attractive manner serve to increase sales opportunities.

On the other hand, because each product has a large number of sizes, colors, and the like, and customers demand that they be provided with merchandise that is just right for them, it is necessary to have available a large quantity of merchandise stock. However, a large quantity of merchandise stock hinders an aesthetically pleasing display, and thus a great deal of this merchandise stock is generally stored in a warehouse.

In addition, because the sale of high-fashion merchandise is limited to a relatively short sale season, and because it is necessary to immediately supply the required merchandise in order to satisfy customer demands, the warehouse that stores the merchandise stock is either disposed inside the store or adjacent thereto, and because a number of store employees remove articles from and add articles to the warehouse in accordance with customer demands, controlling what goes in and out thereof is arduous.

On the other hand, because running out of merchandise could result in lost sales opportunities, the merchandise stock must always be sufficiently replenished, making stock control an important but burdensome issue for the store. Therefore, stock control based on counting the number of articles sold or the number of items taken in and out of the warehouse has been proposed.

A conventional merchandise control system shown in FIG. 6 has a merchandise quantity information storage means 1, a merchandise quantity information update means 2, and a merchandise quantity information providing means 5. The merchandise quantity information storage means 1 stores the sales volume n for each article, the merchandise quantity update means 2 counts sales volume by incrementing by one the sales volume n that is stored in the merchandise quantity information storage means 1 for each merchandise item sold, and the merchandise quantity information providing means 5 provides the sales volume n for each product stored in the merchandise quantity information storage means 1.

In a conventional merchandise control system constructed in this manner, the required stock is maintained by replenishing the merchandise in response to the sales volume n provided by the merchandise quantity information providing means 5.

Another conventional merchandise control system in FIG. 7 has a merchandise quantity information storage means 1, a merchandise quantity information update means 2, and a merchandise quantity information providing means 5. The merchandise quantity information storage means 1 stores the sales volume n for each merchandise item, the merchandise quantity information update means 2 updates the stock count by applying the change in quantity [n] for each article replenished or delivered to the number of articles that are in stock, i.e., the number n stored in the merchandise quantity information storage means 1, and the merchandise quantity information providing means 5 provides the stock count n for each product, stored in the merchandise quantity information storage means 1.

In a conventional merchandise control system constructed in this manner, when the number of articles in stock [n] provided by the merchandise quantity information providing means 5 reaches a certain value that includes zero, the required stock is maintained by adding the number of articles needed for maintaining the required stock level.

However, in the conventional merchandise control systems shown in FIGS. 6 and 7 there will typically be an excessive number of articles in the stock or the articles will be sold out, especially since the replenishment of stock occurs with a certain amount of delay following a replenishment decision because of steps such as ordering and delivery of articles.

Thus, the optimal number of replenishment items should take into account the number of articles that will be consumed or sold from the time that a replenishment decision has been made until the actual replenishment occurs. In other words, consumption continues even after the replenishment decision is made, and the replenishment should ideally occur just as the stock level reaches zero.

However, in the conventional merchandise control system shown in FIG. 6, replenishment occurs in accordance with the number of articles sold, and when replenishment does occur, the stock level always returns to the predetermined level, i.e., the stock level that was initially set. However, there is no guarantee that all of the stock will be consumed down to zero at the next replenishment.

Thus, if the predetermined stock level is not adequate, a shortage will occur and sales opportunities will be lost. On the other hand, if a stock level that is too high is set because of the fear about lost sales opportunities, an excessive stock level will result.

In general, the predetermined number of stock items is based on an estimate of the number of items that will be consumed from the time that a replenishment decision is made until the actual replenishment occurs, in an effort to maintain the ideal stock level. However, because the number of articles sold changes according to the season, an excessive target tends to be set.

Furthermore, with high-fashion merchandise, new merchandise designs are constantly being introduced into the market, and as a result, there are many times in which sales opportunities will have been lost by the time the actual sales records become available. Therefore, one has no choice but to establish a less than optimum stock level, being forced to choose between lost sales opportunities and an excessive stock level that may result in unsold articles.

Likewise with the other conventional merchandise control system shown in FIG. 7, articles are added to always return the stock level to the initial setting. However there is no guarantee that this initial setting is the appropriate level.

A second drawback of the conventional merchandise control systems shown in FIGS. 6 and 7 is that they cannot detect when the number of articles displayed in the store reaches zero and that sales opportunities are being lost.

As was noted previously, a store's stock consists of not only the merchandise displayed in the store but also the merchandise that is stored in a warehouse adjacent to the store. However, only those articles being displayed in the store are being exposed to customers' buying opportunities.

Thus, if a certain article is not displayed in the store, but rather all of it is stored in the warehouse, it is extremely rare that such an article might get sold.

The conventional merchandise control systems shown in FIGS. 6 and 7 do count the number of articles sold or the number of stock items. However, these systems cannot determine the number of articles being displayed in the store from these numbers. Thus, even if the number of articles being displayed in the store reaches zero, the merchandise quantity information providing means 5 cannot indicate this fact.

In addition, a fourth drawback of the conventional merchandise control system is that it cannot detect that the number of stock items has reached zero and that sales opportunities are being lost.

In the conventional merchandise control system shown in FIG. 6, the number of articles sold is counted, but the number of stock items is not. Thus, even when the number of stock items has reached zero and sales opportunities are being lost, the merchandise quantity information providing means 5 cannot provide any information.

A fifth drawback of the conventional merchandise control system shown in FIG. 7 is that although it can count the number of stock items, and the merchandise quantity information providing means 5 can indicate that the number of stock items has reached zero, it has a low degree of reliability with respect to the quantity of articles that must be added.

As explained above, only those articles being displayed in the store are being exposed to customers' buying opportunities.

The conventional merchandise control system shown in FIG. 7 recognizes that the reduction in the number of articles in stock must be made up by adding the same number of articles. However, if there is a period in which the number of articles being displayed in the store reaches zero during a single replenishment cycle, the quantity of articles that should have been sold during this period is not counted, creating a discrepancy between such a quantity and the sales volume during a single replenishment period, which is the ideal replenishment volume.

On the other hand, if one notices that the number of articles being displayed in the store has reached zero, and brings a large number of articles into the store display, the number of stock items declines rapidly and the stock will have to be replenished with a large number of articles. However, in reality, only the location of the stock has changed to the store, increasing the number of articles being displayed in the store to a level that does not realistically match the sales volume.

In other words, the conventional merchandise control system shown in FIG. 7 has a drawback in that it cannot differentiate between the withdrawal of articles from the warehouse situated adjacent to the store and the actual sales, and thus can provide only ambiguous figures for the actual sales volume and the number of articles to be added to the stock.

### SUMMARY

A merchandise control system according to the present invention includes merchandise quantity information storage means, means for updating said merchandise quantity information, means for storing the history of said merchandise quantity information, and means for providing said merchandise quantity information and said merchandise quantity information history, and preferably also includes some or all of the following features:

The merchandise quantity information storage means has at least multiple sales volumes at different times as merchandise quantity information.

The merchandise quantity information update means has at least a sales volume adding means.

The means for providing merchandise quantity information and merchandise quantity history has at least a means for calculating the number of articles purchased during a given period of time, based on the sales volumes at different times.

The merchandise quantity information storage means has information relating to sales price as merchandise quantity information.

The means for providing merchandise quantity information and merchandise quantity information history has at least a means for calculating sales prices based upon the information relating to the sales volume and sales prices at different times.

The means for providing merchandise quantity information and merchandise quantity information history has a means of notifying a customer of a sales price via a communication means.

The merchandise quantity information storage means has at least the number of articles being displayed in a store as merchandise quantity information.

The merchandise quantity information update means has at least a means for adding and subtracting the number of articles being displayed in the store.

The merchandise quantity information storage means has at least multiple numbers of articles being displayed in the front of a store at different times.

The merchandise quantity information storage means has at least the number of articles in stock in a store's warehouse as merchandise quantity information.

The merchandise quantity information update means has at least a means for adding and subtracting the number of stock items in the store's warehouse.

The merchandise quantity information storage means has at least the number of articles being displayed in the store and the number of items in stock in a store's warehouse as merchandise quantity information.

The means for providing merchandise quantity information and merchandise quantity information history has a means for forecasting the time in which the sum of the number of articles on display and the number of stock items will be consumed.

The means for providing merchandise quantity information and merchandise quantity information history has a means for indicating the time in which the sum of the number of articles on display and the number of stock items will be consumed, via a communication means.

The merchandise quantity information history storage means has at least a means for storing the historical data relating to said merchandise quantity information at intervals shorter than the store's operating hours.

The merchandise quantity information includes information relating to the merchandise quantity of a virtual store that is created in a computer.

The merchandise quantity information has at least merchandise quantity information for apparel, shoes, handbags, wallets, or other merchandise.

### BRIEF DESCRIPTION OF THE DRAWINGS

Certain embodiments of the merchandise control system of the present invention will now be described with reference to the appended Drawings, in which:

FIG. 1 shows a first embodiment of the merchandise control system of the present invention.

FIG. 2 shows a second embodiment of the merchandise control system of the present invention.

FIG. 3 shows a third embodiment of the merchandise control system of the present invention.

FIG. 4 shows a fourth embodiment of the merchandise control system of the present invention.

FIG. 5 shows a fifth embodiment of the merchandise control system of the present invention.

FIG. 6 shows an example of the construction of a conventional merchandise control system.

FIG. 7 shows another example of the construction of a conventional merchandise control system.

### DETAILED DESCRIPTION OF EXEMPLARY EMBODIMENTS

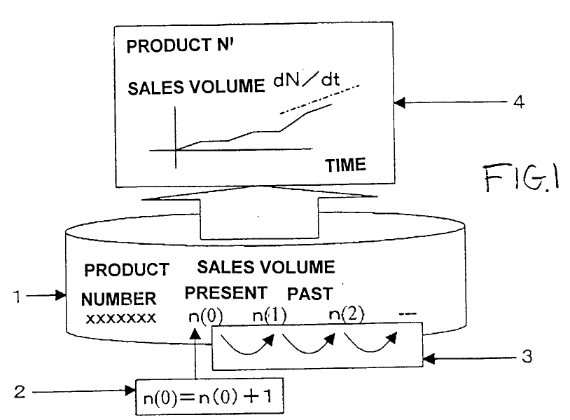

The embodiment shown in FIG. 1 has a merchandise quantity information storage means 1, a merchandise quantity update means 2, a merchandise information history storage means 3, and a merchandise quantity information and merchandise quantity information history providing means 4. The merchandise quantity information storage means 1 has the current and past sales volumes n(0), n(1), n(2), etc. for each article. Every time an article is sold, the merchandise quantity update means 2 adds 1 to the current sales volume n(0) that is held in the merchandise quantity information storage means 1. The merchandise information history storage means 3 sequentially shifts, at fixed time intervals, the current sales volume n(0) held in the merchandise quantity information storage means 1 to a first historical past sales volume n(1), and sequentially shifts the first historical past sales volume n(1) to a second historical past sales volume n(2). The merchandise quantity information and merchandise quantity information history providing means 4 indicates the direction in which sales volume has been moving from the past to the present using the current and past sales volumes n(0), n(1), n(2), etc. held in the merchandise quantity information storage means 1.

In the first embodiment shown in FIG. 1 constructed in this manner, the merchandise quantity information and merchandise quantity information history providing means 4 can provide not only the integral value of the sales volume up to the present, but also the sales volume per unit of time dN/dt from the past. Therefore, even if the sales volume changes according to the season, it is possible to more accurately forecast sales volume within a given period of time in the future as long as the changes follow a continuous function over time, and thus it is possible to determine the appropriate replenishment quantity.

In addition, even in situations when new merchandise, such as high-fashion merchandise, is continuously being introduced into the market, if the historical replacement cycle is made sufficiently short for the merchandise information history storage means 3, the sales trend can be obtained quickly after the introduction of the new merchandise. Therefore, the time needed for the quantity initially stocked to be sold can be forecast, and replenishment can occur before the merchandise is sold out.

The second embodiment shown in FIG. 2 has a merchandise quantity information storage means 1, a merchandise quantity update means 2, a merchandise information history storage means 3, and a merchandise quantity information and merchandise quantity information history providing means 4. The merchandise quantity information storage means 1 has for each article, a list price as the information related to the article's sales price, a target sales volume per unit time, as well as the current and past sales volumes n(0), n(1), n(2), etc. Every time an article is sold, the merchandise quantity update means 2 adds 1 to the current sales volume n(0) that is held in the merchandise quantity information storage means 1. The merchandise information history storage means 3 sequentially shifts, at fixed time intervals, the current sales volume n(0) held in the merchandise quantity information storage means 1 to a first historical past sales volume n(1), and sequentially shifts the first historical past sales volume n(1) to a second historical past sales volume n(2). The merchandise quantity information and merchandise quantity information history providing means 4 indicates the direction in which sales volume has been moving from the past to the present using the current and past sales volumes n(0), n(1), n(2), etc. held in the merchandise quantity information storage means 1, calculates the sales volume per unit of time dN/dt, calculates a price from the list price and the target sales volume, and presents the result to the customer by means of a communication means.

A communication terminal 6 is shown to represent the customer to whom the price information provided by the merchandise quantity information and merchandise quantity information history providing means 4 is to be communicated.

In the second embodiment shown in FIG. 2 constructed in this manner, the merchandise quantity information and merchandise quantity information history providing means 4 can provide the sales volume up to the present, not as an integral value, but as the details from the past, making it possible to determine an appropriate replenishment quantity. In addition, even in situations where new merchandise, such as high-fashion merchandise, is being continuously introduced into the market, this embodiment can forecast the time it will take for the quantity initially stocked to be sold, and replenishment can occur before the merchandise is sold out. These features are the same as in the first embodiment shown in FIG. 1. Additionally, the second embodiment has an advantage in that it can suggest a price appropriate for sales promotion to the customer.

In other words, through appropriate calculation, the merchandise quantity information and merchandise quantity information history providing means 4 can calculate a sales price from the sales volume per unit time dN/dt, the target sales volume, and the list price.

Assume a situation in which a sale price is calculated by multiplying the list price by the value of the sales volume per unit of time dN/dt divided by the target value, i.e.,

{Price}={list price}×({sales volume per unit of time dN/dt}/{target value})

If the sales volume per unit of time does not reach the target value, the sale price is automatically lowered, and when the sales volume exceeds the target value, the sale price is raised.

Thus, if a more complex method is used for calculating the sale price, an effective sales price can be obtained, and if this price is communicated to the customer by means of a communication means, sales opportunities will increase.

When articles remain as unsold stock in a store, they are generally shipped to a warehouse first, stored until the time of a special sales, transported to the special sales location, and sold at discounted prices.

Thus, in the resale of unsold merchandise, transportation and warehousing costs are incurred twice, along with a discount expense.

According to the second embodiment shown in FIG. 2, when it looks as though there will be unsold merchandise, it will be discounted. However, expenses, such as the cost of returning the merchandise to the warehouse, the storage cost, and the cost of shipping the merchandise to the special sale location, can be reduced.

In addition, in the second embodiment shown in FIG. 2, if the information held in the merchandise quantity information storage means 1 is information relating to a virtual store created in a computer, it will be possible to suggest a current price that is in line with the sales trend even when there is no unit sales. As a result, it will be possible to construct an auction system for selling large quantities of the same product, which has historically been difficult.

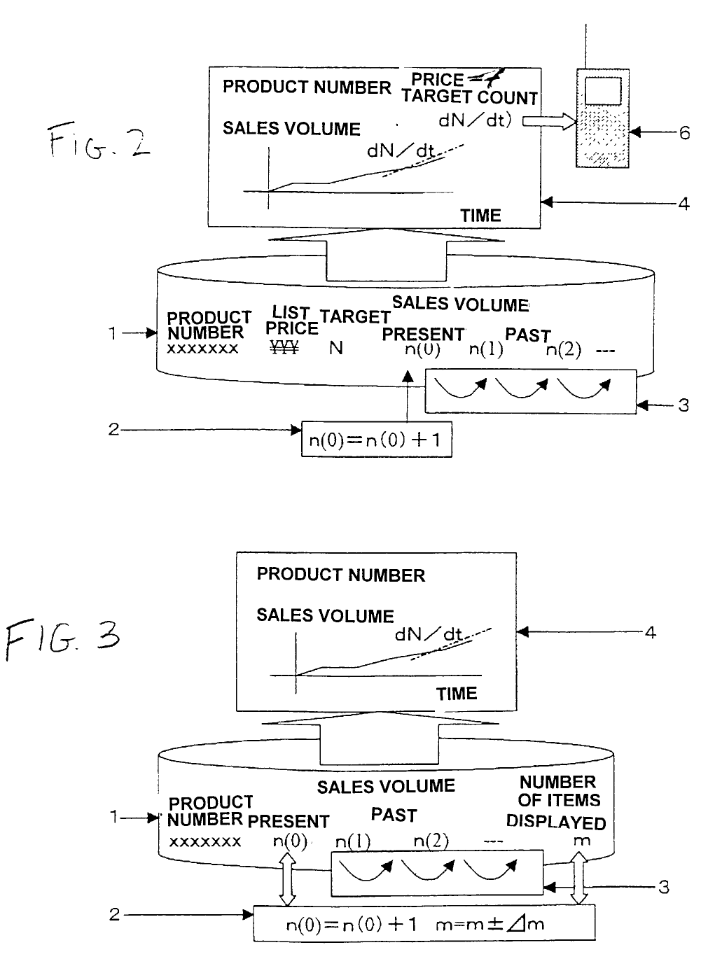

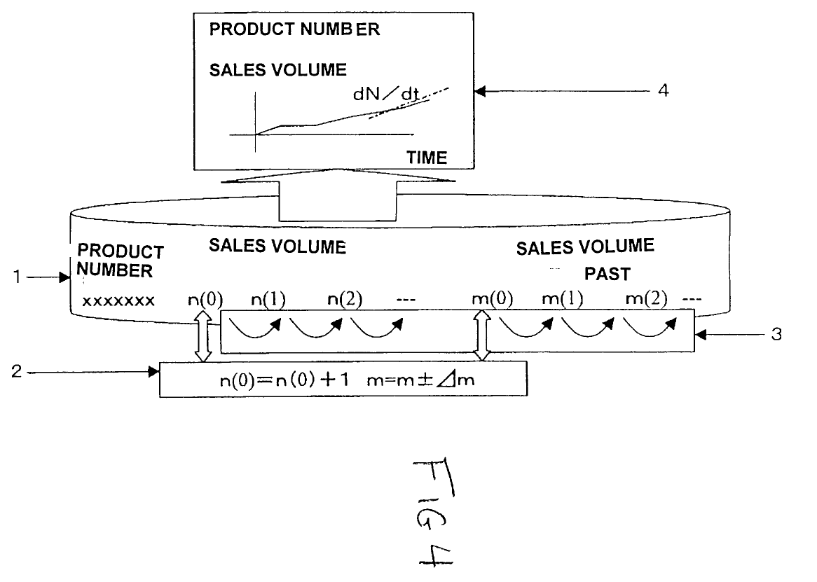

The third embodiment shown in FIG. 3 has a merchandise quantity information storage means 1, a merchandise quantity update means 2, a merchandise information history storage means 3, and a merchandise quantity information and merchandise quantity information history providing means 4. The merchandise quantity information storage means 1 has for each article, the current and past sales volumes n(0), n(1), n(2), etc. and the number of articles m that are currently being displayed in the store. Every time an article is sold, the merchandise quantity update means 2 adds 1 to the current sales volume n(0) that is held in the merchandise quantity information storage means 1, subtracts 1 from the present display number m, and whenever articles are moved from a warehouse associated with the store to the store, adds the moved quantity to the present display number m. The merchandise information history storage means 3 sequentially shifts, at fixed time intervals, the current sales volume n(0) held in the merchandise quantity information storage means 1 to a first historical past sales volume n(1), and sequentially shifts the first historical past sales volume n(1) to a second historical past sales volume n(2). The merchandise quantity information and merchandise quantity information history providing means 4 indicates the direction in which sales volume has been moving from the past to the present using the current and past sales volumes n(0), n(1), n(2), etc. held in the merchandise quantity information storage means 1.

In the third embodiment shown in FIG. 3 that is constructed in this manner, the merchandise quantity information and merchandise quantity information history providing means 4 can provide the sales volume up to the present, not as an integral value, but as the details from the past, making it possible to determine an appropriate replenishment quantity. In addition, even in situations where new merchandise, such as high-fashion merchandise, is being continuously introduced into the market, this embodiment can forecast the time it will take for the quantity initially stocked to be sold, and replenishment can occur before the merchandise is sold out. These features are the same as in the first embodiment shown in FIG. 1. Additionally, the third embodiment has an advantage in that it can reduce lost sales opportunities and determine the amount of merchandise that needs replenishment with a higher degree of accuracy.

In other words, when the number of articles being displayed in the store reaches zero, the merchandise quantity information and merchandise quantity information history providing means 4 can detect this fact in terms of the present number of display items m, and thus can prompt the store personnel to replenish the store display. Thus, the loss of sales opportunities that can be caused by the absence of merchandise displayed in the store can be reduced.

The fourth embodiment shown in FIG. 4 has a merchandise quantity information storage means 1, a merchandise quantity update means 2, a merchandise information history storage means 3, and a merchandise quantity information and merchandise quantity information history providing means 4. The merchandise quantity information storage means 1 has for each article, the current and past sales volumes n(0), n(1), n(2), etc. and the past and present numbers of articles m(0), m(1), m(2), etc. displayed in the store. Every time an article is sold, the merchandise quantity update means 2 adds 1 to the current sales volume n(0) that is held in the merchandise quantity information storage means 1, subtracts 1 from the present display number m(0), and whenever articles are moved from a warehouse associated with the store to the store, adds the moved quantity to the present display number m(0). The merchandise information history storage means 3 sequentially shifts, at fixed time intervals, the current sales volume n(0) held in merchandise quantity information storage means 1 and the present display number m(0) to a first historical past sales volume n(1) and a display number m(1), respectively, and sequentially shifts the first historical past sales volume n(1) and a display number m(1) to a second historical past sales volume n(2) and a display number m(2). The merchandise quantity information and merchandise quantity information history providing means 4 indicates the direction in which sales volume has been moving from the past to the present using the current and past sales volume n(0), n(1), n(2), etc. held in the merchandise quantity information storage means 1.

In the fourth embodiment shown in FIG. 4 that is constructed in this manner, the operation and effect thereof are nearly the same as those in the embodiment shown in FIG. 3, and thus a detailed description will be omitted. However, the fourth embodiment has an advantage in that it more accurately calculates the number of sales per unit of time.

In other words, because the merchandise quantity information and merchandise quantity information history providing means 4 can recognize when the number of merchandise items being displayed in the store reaches zero in the form of the present number of displayed items m(0) and a past numbers of displayed items m(1), m(2), etc., it can accurately recognize the time period in which the merchandise will be consumed by calculating changes in the sales volume per unit of time, and thus can more accurately calculate the replenishment quantity needed.

In addition, when few articles are displayed in the store, the opportunity for a customer to view the merchandise diminishes, and thus the opportunity to make a sale will inevitably diminish.

The fourth embodiment shown in FIG. 4 can also take this phenomenon into consideration when determining the replenishment quantity. To obtain a more precise and accurate sales volume per unit of time and replenishment quantity, it is preferable that the history update time for merchandise information history storage means 3 be set for a period that is shorter than the store's operating hours.

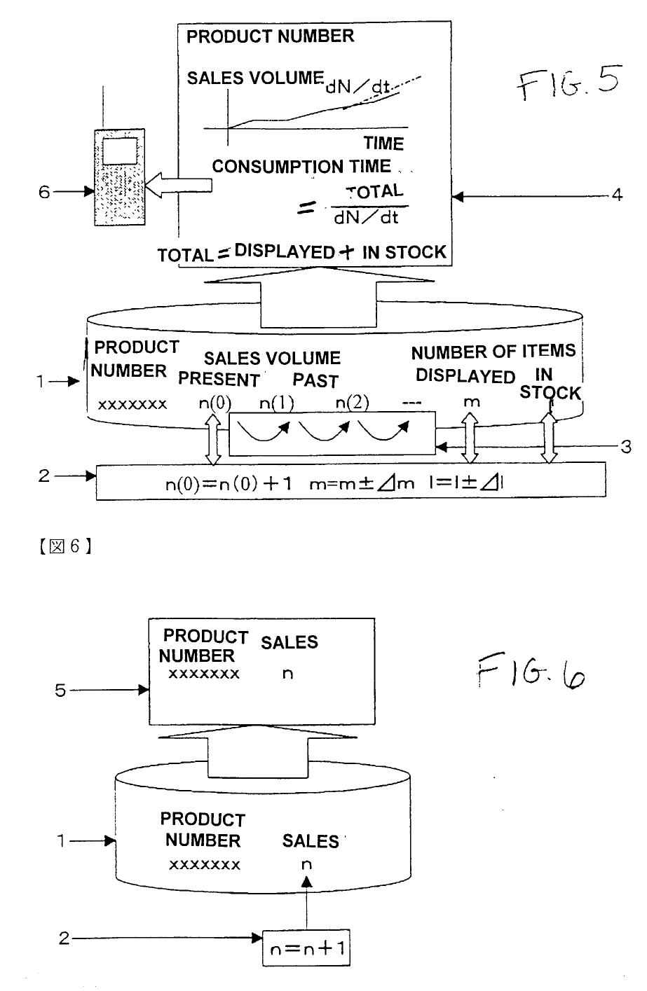

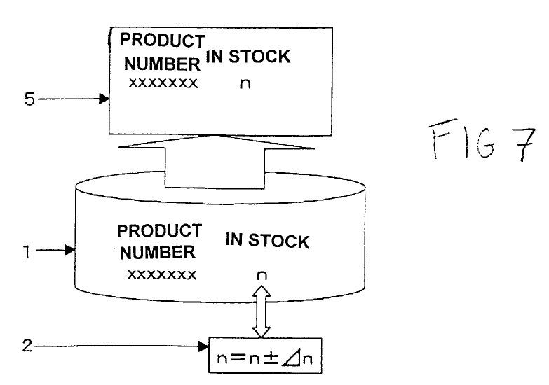

The fifth embodiment shown in FIG. 5 has a merchandise quantity information storage means 1, a merchandise quantity update means 2, a merchandise information history storage means 3, and a merchandise quantity information and merchandise quantity information history providing means 4. The merchandise quantity information storage means 1 has for each article, the current and past sales volumes n(0), n(1), n(2), etc. the number of articles m that are currently being displayed in the store, and the number of items in stock I in the store's warehouse. Every time an article is sold, the merchandise quantity update means 2 adds 1 to the current sales volume n(0) that is held in the merchandise quantity information storage means 1, subtracts 1 from the present display number m, and whenever articles are moved from a warehouse associated with the store to the store, adds the moved quantity to the present display number m stored in the merchandise quantity information storage means 1, and subtracts this number from the number of items in stock 1. Whenever articles are brought into the warehouse, the number of items brought in is added to the present number of items in stock 1 stored in the merchandise quantity information storage means1. The merchandise information history storage means 3 sequentially shifts, at fixed time intervals, the current sales volume n(0) held in the merchandise quantity information storage means 1 to a first historical past sales volume n(1), and sequentially shifts the first historical past sales volume n(1) to a second historical past sales volume n(2). The merchandise quantity information and merchandise quantity information history providing means 4 indicates the direction in which the number of articles on display has been moving from the past to the present, i.e., the sales volume trend and the time necessary for consuming the entire quantity in the inventory, using the current and past sales volume n(0), n(1), n(2), etc. held in the merchandise quantity information storage means 1, and provides these figures to the warehouse by means of a communication means.

The total number of items in the store inventory is the sum of the present number of display items m and the number of items in stock 1. If we assume that the number of articles sold per unit of time is dN/dt, then {Time needed for consumption}={total number of items in stock}/dN/dt {Total number of items in stock}={number of display items m}+{number of items in stock I}.

A communication terminal 6 is shown to represent the warehouse to which the replenishment information provided by the merchandise quantity information and merchandise quantity information history providing means 4 is to be communicated.

In the fifth embodiment shown in FIG. 5 that is constructed in this manner, the merchandise quantity information and merchandise quantity information history providing means 4 can provide the sales volume up to the present, not as an integral value, but as the details from the past, making it possible to determine an appropriate replenishment quantity. In addition, even in situations where new merchandise, such as high-fashion merchandise, is being continuously introduced into the market, this embodiment can forecast the time it will take for the quantity initially stocked to be sold, and replenishment can occur before the merchandise is sold out, thus reducing lost sales opportunities and making it possible to determine more accurate replenishment quantities. These features are the same as in the third embodiment shown in FIG. 3. Additionally, this fifth embodiment has an advantage in that it can accelerate an optimal replenishment decision.

In other words, if a request for replenishment is made to the warehouse exactly at the point when the time needed for the merchandise to be completely sold out equals the time needed for replenishment, then by the time the actual replenishment occurs in accordance with the replenishment request, the store inventory will have been completely consumed, reaching 0.

Furthermore, because the number of items to be replenished can be determined based on the sales volume trend at the time the replenishment decision is made, an appropriate replenishment quantity can be obtained, making possible a replenishment decision that is ideal both in timing and quantity.

As explained above, different embodiments of the above-described merchandise control system can produce some or all of the following benefits:

First, the system provides a suitable quantity of merchandise stock in a store, and prevents merchandise from being overstocked or unsold.

Second, the system also guards against the loss of sales opportunities due to merchandise being sold out.

Third, the system detects when the merchandise being displayed in the front of a store has been sold out, and guards against the loss of sales opportunities.

Fourth, even if the sales volume changes by season, for example, the system can forecast the sales volume within a given period of time in the future, and can determine the appropriate replenishment quantity.

Fifth, even when new merchandise is being introduced into the market, the sales trend can be obtained quickly after the introduction of the new merchandise. Therefore, the system can forecast the time needed for the quantity initially stocked to be sold, making replenishments possible before the merchandise is sold out.

Sixth, the system can obtain an effective sales price, and communicating this price to customers can increase sales opportunities.

Seventh, the system can reduce the various discount sales-related expenses that would be incurred if articles remain unsold in the store.

Eighth, by providing a price that is in line with the current sales trend, the system can produce an effective auction system that can sell a large quantity of the same products.

1. A merchandise control system comprising:
merchandise quantity information storage means,
means for updating said merchandise quantity information, a
means for storing the history of said merchandise quantity information, and
means for providing said merchandise quantity information and said merchandise quantity information history.

2. The merchandise control system according to claim 1, wherein the merchandise quantity information storage means stores at least multiple sales volumes at different times as merchandise quantity information.

3. The merchandise control system according to claim 2, wherein the merchandise quantity information update means includes at least sales volume adding means.

4. The merchandise control system according to claim 2, wherein the means for providing merchandise quantity information and merchandise quantity information history includes at least means for calculating the number of articles purchased during a given period of time, based on the sales volumes at different times.

5. The merchandise control system according to claim 2, wherein the merchandise quantity information storage means stores information relating to sales price together with the merchandise quantity information.

6. The merchandise control system according to claim 5, wherein the means for providing merchandise quantity information and merchandise quantity information history includes at least means for calculating sales prices based upon the information relating to the sales volume and sales prices at different times.

7. The merchandise control system according to claim 6, wherein the means for providing merchandise quantity information and merchandise quantity information history includes means for notifying a customer of a sales price via a communication means.

8. The merchandise control system according to claim 2, wherein the merchandise quantity information storage means stores at least the number of articles being displayed in a store as merchandise quantity information.

9. The merchandise control system according to claim 8, wherein the merchandise quantity information update means includes at least means for adding and subtracting the number of articles being displayed in the store.

10. The merchandise control system according to claim 8, wherein the merchandise quantity information storage means stores numbers of articles displayed at the front of the store at different times.

11. The merchandise control system according to claim 2, wherein the merchandise quantity information storage means stores at least the number of stock items in a store's warehouse as merchandise quantity information.

12. The merchandise control system according to claim 11, wherein the merchandise quantity information update means includes at least means for adding and subtracting the number of stock items in the store's warehouse.

13. The merchandise control system according to claim 2, wherein the merchandise quantity information storage means stores at least the number of articles being displayed in the store and the number of stock items in a store's warehouse as merchandise quantity information.

14. The merchandise control system according to claim 13, wherein the means for providing merchandise quantity information and merchandise quantity information history includes means for forecasting the time in which the sum of the number of articles on display and the number of stock items will be consumed.

15. The merchandise control system according to claim 14, wherein the means for providing merchandise quantity information and merchandise quantity information history includes means for communicating the time in which the sum of the number of articles on display and the number of stock items will be consumed.

16. The merchandise control system according to claim 1, wherein the merchandise quantity information history storage means stores historical data relating to said merchandise quantity information at intervals shorter than the store's operating hours.

17. The merchandise control system according to claim 1, wherein the merchandise quantity information includes information relating to the merchandise quantity of a virtual store that is created in a computer.

18. The merchandise control system according to claim 1, wherein the merchandise quantity information includes at least merchandise quantity information for merchandise selected from the group consisting of apparel, shoes, handbags, and wallets.
